(19) United States
(12) Patent Application Publication
(10) Pub. No.: US 2018/0212270 A1
(43) Pub. Date: Jul. 26, 2018

(54) GRAPHITE MODIFIED LITHIUM METAL ELECTRODE

(71) Applicant: 3M INNOVATIVE PROPERTIES COMPANY, St. Paul, MN (US)

(72) Inventors: Larry J. Krause, Stillwater, MN (US); Lowell D. Jensen, Stillwater, MN (US)

(21) Appl. No.: 15/747,778

(22) PCT Filed: Jul. 21, 2016
(86) PCT No.: PCT/US2016/043291

§ 371 Date: Jan. 26, 2018

Related U.S. Application Data
(60) Provisional application No. 62/197,203, filed on Jul. 27, 2015.

(51) Int. Cl. H01M 10/058; H01M 10/0525; H01M 4/1393; H01M 4/36; H01M 4/38; H01M 4/587; H01M 12/08

(52) U.S. Cl. CPC H01M 10/058; H01M 10/0525; H01M 4/1393; H01M 12/08; H01M 4/382; H01M 4/587; H01M 4/366

(57) ABSTRACT

Lithium metal electrodes including a graphite-modified surface and the methods for making the electrodes are provided. Electrochemical device components include a lithium metal electrode having a first major surface, and a surface layer disposed on the first major surface of the lithium metal electrode. The surface layer has a composition including a compound of graphite and lithium. The surface layer is electrically conductive and lithium-ion conductive, and the surface layer is chemically compatible with the lithium metal on a first side in contact with the lithium metal electrode, and chemically compatible with electrolyte environments on a second side of the surface layer.

### TECHNICAL FIELD

The present disclosure relates to lithium metal electrodes including a graphite-modified surface for a lithium battery, and the methods of making the same.

### BACKGROUND

Various methods have been employed to make battery electrodes and/or deposit materials useful in battery electrodes. For example, methods are described in U.S. Pat. No. 5,720,780 (Liu et al.), U.S. Pat. No. 6,589,299 (Missling et al.), U.S. Pat. No. 6,939,383 (Eastin et al.), U.S. Patent Application Publication 2010/0055569 (Divigalpitiya et al.), and JP Pub. No. 2009 252629 (Toshiya et al.).

### SUMMARY

Briefly, in one aspect, the present disclosure describes an electrochemical device component including a lithium metal electrode having a first major surface, and a surface layer disposed on the first major surface of the lithium metal electrode. The surface layer has a composition including a compound of graphite and lithium. The surface layer is electrically conductive and lithium-ion conductive. The surface layer is chemically compatible with the lithium metal on a first side in contact with the lithium metal electrode, and chemically compatible with electrolyte environments on a second side of the surface layer.

In another aspect, the present disclosure describes a method of making an electrochemical device component. The method includes providing a lithium metal electrode having a first major surface and treating the first major surface of the lithium metal electrode to form a surface layer. The surface layer has a composition including a compound of graphite and lithium. The surface layer is electrically conductive and lithium-ion conductive. The surface layer is chemically compatible with the lithium metal on a first side in contact with the lithium metal electrode, and chemically compatible with electrolyte environments on a second side of the surface layer.

Various unexpected results and advantages are obtained in exemplary embodiments of the disclosure. One such advantage of exemplary embodiments of the present disclosure is that the surface layer is formed by the reaction between a graphite coating and a lithium metal electrode, and the interface between the surface layer and the lithium metal electrode can be a coherent, and substantially pinhole-free interface that exhibits superior electrical, electrochemical, and mechanical properties.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic side view of an electrochemical device component including a lithium metal electrode with a surface layer, according to one embodiment.

FIG. 2 illustrates a process of forming the surface layer of FIG. 1 after applying a graphite coating onto the lithium metal electrode, according to one embodiment.

FIG. 3 is results of thermal parasitic energy measurement as a function of cycle for Examples.

FIG. 4 is results of voltage hysteresis measurement as a function of cycle for Examples.

In the drawings like reference numerals indicate like elements. While the above-identified drawing, which may not be drawn to scale, sets forth various embodiments of the present disclosure, other embodiments are also contemplated, as noted in the Detailed Description. In all cases, this disclosure describes by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “coherent interface” used herein refers to an interface between a lithium metal electrode and a surface layer across which the microstructure thereof is continuous resulting from the reaction between the metal electrode surface and an initial material coating disposed thereon.

The term “graphite” refers to a crystalline form of carbon having a layered, planar structure. In each layer, the carbon atoms are arranged in a honeycomb lattice with separation of about 0.142 nm, and the distance between planes is about 0.335 nm. The graphite described herein is capable of reacting with lithium metal, and forming a lithium graphite intercalation compound (Li-GIC) where lithium metal ions are intercalated into the layered structure of graphite.

The term “lithium metal” refers to lithium element in the form of metal that is capable of reacting with a graphite coating in contact therewith at room temperatures to form a lithium graphite intercalation compound (Li-GIC).

As used herein, “buffing” refers to any operation in which a pressure normal to a subject surface (e.g., a major surface of a metallic substrate) coupled with movement (e.g., rotational, lateral, combinations thereof) in a plane parallel to said subject surface is applied.

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

By using the term “overcoated” to describe the position of a layer with respect to a substrate or other element of an article of the present disclosure, we refer to the layer as being atop the substrate or other element, but not necessarily contiguous to either the substrate or the other element.

By using the term “separated by” to describe the position of a layer with respect to other layers, we refer to the layer as being positioned between two other layers but not necessarily contiguous to or adjacent to either layer.

The terms “about” or “approximately” with reference to a numerical value or a shape means +/− five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Electrochemical cells, such as lithium-ion electrochemical cells include a negative electrode and a positive electrode where lithium (Li) ions can be transferred between the positive and negative electrode through a lithium-ion-conducting electrolyte. In Li-ion batteries, Li intercalation compounds can be used as positive electrode (cathode) materials, and graphite can be used as negative electrode (anode) materials where Li ions can be intercalated into its layered structure. In Li metal batteries, the positive electrode (cathode) can include, for example, Li intercalation compounds, sulphur, or air electrodes, and the negative electrode (anode) is lithium (Li) metal. Li metal has specific properties such as a high specific capacity, low density, and a very negative electrochemical potential, all of which are advantageous for electrodes for rechargeable batteries or electrochemical cells. The main challenges for developing lithium metal batteries include, for example, the growth of Li dendrites during repeated charge/discharge processes (e.g., lithium plating and stripping), and excessive reactivity with organic electrolytes leading to the development of mossy lithium metal deposits. The problems can lead to dendritic electrical shorts in rechargeable batteries or cell and thermal runaway.

The present disclosure describes rechargeable batteries or electrochemical cells based on lithium (Li) metal electrodes including a graphite-modified surface that can overcome the challenges discussed above. In some embodiments, electrochemical device components are provided. The electrochemical device components can include a lithium metal electrode having a first major surface. A surface layer is disposed on the first major surface of the lithium metal. The surface layer can have a composition including a compound of graphite and lithium. The microstructure across the interface between the surface layer and the lithium metal can be continuous, which may result from a reaction between the lithium metal and a graphite coating thereon. The surface layer can be electrically conductive, and lithium-ion conductive. In addition, the surface layer can be chemically compatible with the lithium metal on a first side in contact with the lithium metal electrode, and chemically compatible with electrolyte environments on a second side opposite the first side.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

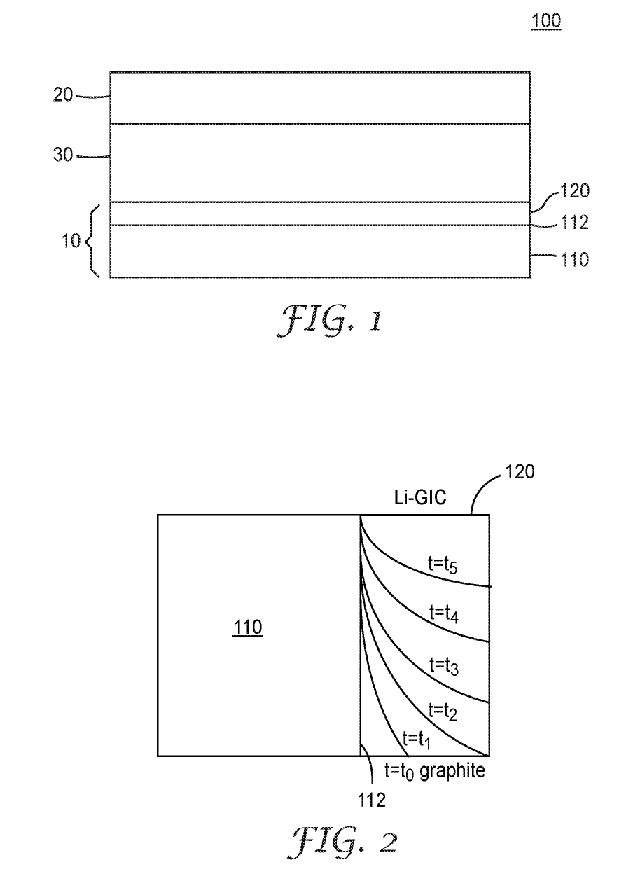

FIG. 1 illustrates a schematic side view of an electrochemical device component 100, according to one embodiment. The electrochemical device component 100 includes a negative electrode 10 and a positive electrode 20. Lithium (Li) ions can be transferred between the positive and negative electrodes 10 and 20 through a lithium-ion-conducting electrolyte 30 during repeated charge/discharge processes. In some embodiments, a separator such as a porous polymer separator (not shown) can be disposed between the negative and positive electrodes 10 and 20.

The negative electrode 10 includes a lithium (Li) metal electrode 110 having a first major surface 112, and a surface layer 120 disposed on the major surface 112. The surface layer 120 has a composition including a compound of graphite and lithium. In some embodiments, the composition of the surface layer 120 includes lithium graphite intercalation compound (Li-GIC) which can be formed by reaction of the lithium metal surface and a graphite coating disposed thereon. Li-GIC may have an approximate composition of LiC₆. In Li-GIC, the graphite has a layered structure, and the lithium ions are intercalated into the layered structure of graphite. The microstructure across the interface between the surface layer 120 and the lithium metal electrode 110 can be continuous where the two sides at the interface are connected by interfacial chemical bonding such as lithium-carbon chemical bonding. At the side of the lithium metal electrode 110, lithium element is in the form of metal, while at the side of the surface layer, lithium ion is intercalated into the layered structure of graphite. It is to be understood that there may be an interface region where the lithium element is gradually changed from the metal form to the intercalated form. The interface region may have a thickness, for example, between a few nanometers and a few microns.

In some embodiments, the surface layer 120 may be substantially uniform with a thickness in the range of a few nanometers to microns, for example, from about 10 nm to about 100 microns, from about 10 nm to about 50 microns, from about 20 nm to about 50 microns, from about 50 nm to about 50 microns, from about 100 nm to about 50 microns, or from about one micron to about 50 microns. In some embodiments, the major surface 112 of the lithium metal electrode 110 may be patterned, and the surface layer 120 can conform to the surface morphology of the major surface 112.

The surface layer 120 is electrically conductive, and lithium-ion conductive. In some embodiments, the surface layer 120 has an electrical conductivity in the range, for example, from about 1×10³ Siemens per centimeter (S/cm) to about 5×10⁴ S/cm at room temperatures. The surface layer 120 can produce an electrically conductive layer on the lithium metal surface which can reduce or eliminate high current distribution areas on the lithium metal surface originating from, for example, a poor primary current distribution caused by a native passive surface layer on the cleaned lithium metal surface. In some embodiments, the surface layer 120 has a lithium-ion conductivity in the range, for example, from about 1×10⁻⁵ S cm²/mol to about 1×10⁻³ S cm²/mol at room temperatures.

By using the lithium metal electrode 110 with the surface layer 112 as a negative electrode (anode) for lithium rechargeable batteries, the lithium metal electrode 110 can serve as a primary lithium ion source during charging/discharging. The reaction of lithium metal electrode 110 can be expressed as the following equation:

Li→Li⁺e⁻

The surface layer 120 is lithium-ion conductive, and lithium ions can be transported between the electrolyte 30 and the major surface 112 of the lithium metal electrode 110 through the surface layer 120. In addition, with the surface layer 120 disposed thereon, the major surface 112 of the lithium metal electrode 110 is separated from the electrolyte environments 30 which may be corrosive to the lithium metal electrode 110. Thus, the surface layer 120 can serve as a barrier layer to provide protection for the lithium metal electrode 110. The surface layer 120 is chemically compatible with lithium metal on a first side in contact with the lithium metal electrode 120, and the surface layer 120 is chemically compatible with electrolyte environments such as the lithium-ion-conducting electrolyte 30 on a second side of the surface layer 120.

In some embodiments, the negative electrode 20 including the surface layer 120 can be prepared by applying a graphite coating onto the major surface 112 of the lithium metal electrode. The applied graphite coating may have a substantially uniform thickness in the range of a few nanometers to microns, for example, from about 10 nm to about 100 microns, or from about 20 nm to about 50 microns. In some embodiments, the graphite coating can be applied to a cleaned lithium metal surface by brushing an effective amount of dry, substantially solvent free graphite powders or flakes onto the cleaned lithium metal surface. In some embodiments, coating of the major surface of the lithium metal electrode can include buffing an effective amount of dry, substantially solvent free graphite composition onto the lithium metal surface. Exemplary buffing processes are described in US Patent Publication No. 2014/0302397 (Bommel et al.), which is incorporated herein by reference. It is to be understood that graphite coating can be applied onto the major surface 112 of the lithium metal electrode by any suitable methods as long as the applied graphite coating can react with the lithium metal to form the surface layer 120.

Buffing of the graphite coating composition may be carried out using any buffing apparatus known in the art (e.g., power sander, power buffer, orbital sander, random orbital sander) suitable for applying dry particles to a surface, or manually (i.e., by hand). An exemplary buffing apparatus may include a motorized buffing applicator (e.g., disc, wheel) which may be configured to apply a pressure normal to a subject surface as well as rotate in a plane parallel to said subject surface. The buffing applicator may include a buffing surface that contacts with, or is intended to contact with, the subject surface during a buffing operation. In some embodiments, the buffing surface may include metal, polymer, glass, foam (e.g., closed-cell foam), cloth, paper, rubber, or combinations thereof. In various embodiments, the buffing surface may be formed of a material having a Brinell hardness of at least 0.1 HB, at least 1 HB, at least 10 HB, at least 100 HB, or even at least 1000 HB.

In some embodiments, the buffing surface may include or otherwise be associated with (e.g., be fitted with) a metal foil (e.g., aluminum foil). That is, the provided methods may include buffing graphite compositions onto a major surface of lithium metal electrodes utilizing a metal foil as a buffing surface.

In some embodiments, the buffing applicator may be configured to move in a pattern parallel to the subject surface and to rotate about a rotational axis perpendicular to the subject surface. The pattern may include a simple orbital motion or random orbital motion. Rotation of the buffing applicator may be carried out as high as 100 orbits per minute, as high as 1,000 orbits per minute, or even as high as 10,000 orbits per minute. The buffing applicator may be applied in a direction normal to the subject surface at a pressure of a least 0.1 g/cm², at least 1 g/cm², at least 10 g/cm², at least 20 g/cm², or even at least 30 g/cm².

In illustrative embodiments, adherence of the graphite coating composition to a major surface of lithium metal electrodes may be assisted by heating the metal electrodes prior to, during, or after the buffing operation to a temperature such that the adhesion of the coating is enhanced. Exemplary methods of heat input to the metal electrodes may include oven heating, heat lamp heating (e.g., infrared), or a heated platen in contact with the metallic substrate. Direct application of electrical currents to conductive substrates may also produce the desired heating affect.

The initially applied graphite coating may have an initial dark color. After being applied onto the cleaned lithium metal surface, the dark graphite coating may turn golden as solid state transport of lithium metal from the major surface 112 into the graphite coating to form a layer of lithium graphite intercalation compound (Li-GIC). Li-GIC may have an approximate composition of, for example, LiC₆. The reaction between the graphite coating and the underlying lithium metal may take, for example, from several minutes to several hours at room temperatures. It is to be understood that other carbon materials (e.g., amorphous carbon) that do not have the graphite structure may not react with the lithium metal to form the surface layer including Li-GIC described herein.

The positive electrode 20 can include any suitable electrode materials such as, for example, LiCoO₂, LiMn₂O₄, LiFePO₄, MoS₂, V₂O₅, elemental sulfur or oxygen, etc. In some embodiments, the positive electrode 20 may include Li intercalation compounds (e.g., LiCoO₂, LiMn₂O₄, LiFePO₄, etc.). In other embodiments, the positive electrode 20 may not include any Li intercalation compounds. The electrolyte 30 can include any suitable electrolyte that allows for lithium-ion movement. Suitable electrolyte can include, for example, lithium salts, such as LiPF₆, LiBF₄ or LiClO₄ in an organic solvent, such as ethylene carbonate, dimethyl carbonate, and diethyl carbonate.

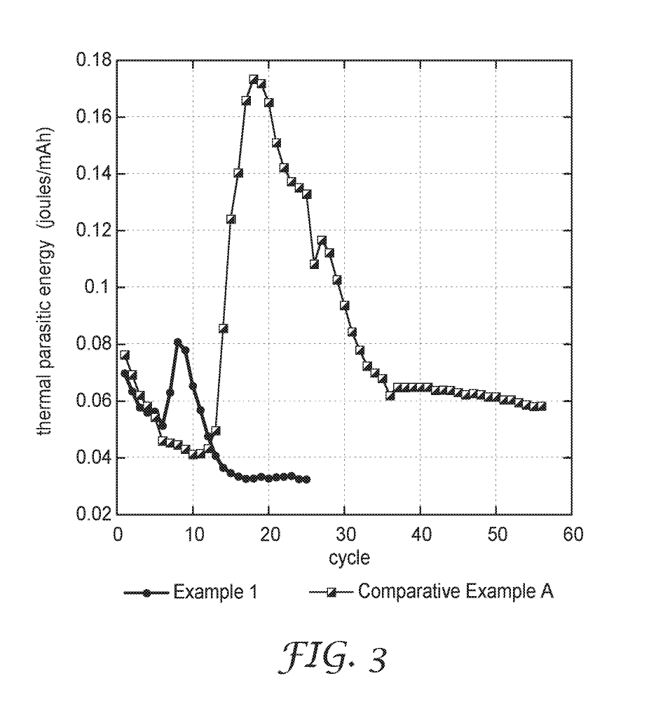

FIG. 2 illustrates a process of forming a surface layer 120 after applying a graphite coating onto the major surface 112 of the lithium metal electrode 110. At time to, the graphite coating is applied onto the major surface 112 and the initial surface layer 120 is a layer of graphite coating. The graphite coating can be, for example, a mixture of graphite powders or flakes and fillers. With increasing time t₁, t₂, t₃, t₄, t₅ . . . , more and more lithium metal ions transport into the graphite coating by diffusing and are intercalated into the layered structure of graphite to form lithium graphite intercalation compound (Li-GIC) having an approximate composition of, for example, LiC₆. A coherent, substantially pinhole-free interface Li/Li-GIC can be formed at the major surface 112 between the surface layer 120 and the lithium metal electrode 110. The density of pinholes at the interface may be, for example, lower than 100 per cm², lower than 20 per cm², lower than 10 per cm², or lower than 5 per cm². In some embodiments, the interface Li/Li-GIC at the surface 112 can be a substantially abrupt interface in terms of composition. That is, the interface region may have a thickness of about several nanometers or less. In other embodiments, the interface Li/Li-GIC can have a gradual change of composition from lithium metal to Li-GIC. That is, the interface region may have a thickness of about several microns or more. It is to be understood that the coherent, substantially pinhole-free interface Li/Li-GIC described herein is formed by the reaction between lithium metal and graphite disposed thereon, which is different from a laminated structure such as a lithium metal electrode laminated with a surface layer of lithium graphite compound mixed with adhesives or other bonding materials. Laminating a surface layer of lithium graphite compound that is already formed to a lithium metal electrode may introduce a high density of pinholes, gaps, and/or impurities (e.g., adhesives or bonding materials) at the interfaces, which are detrimental to device performance. Also, the laminated structure may have inferior mechanical, electrical, and electrochemical properties.

Graphite may be provided in form of flakes or powders with various shapes and dimensions. In some embodiments, graphite flakes or powders may have a dimension in the range, for example, of several nanometers to several tens microns. The graphite material described in this disclosure is distinguished from other carbon materials such as amorphous carbon for its high crystallinity and layered structure for lithium-intercalation. It is to be understood that amorphous carbon may not react with a lithium metal electrode at room temperatures to form a Li-GIC described herein.

In some embodiments, the graphite coating may include fillers mixed with graphite flakes or powders to increase its mechanical properties. The fillers may be polymeric fillers such as, for example, polyvinylidene difluoride (PVDF), styrene-butadiene rubber (SBR), carbomethoxy cellulose, etc. In some embodiments, the graphite coating may include no more than 30 wt %, no more than 20 wt %, or nor more than 10 wt % of fillers. In some embodiments, the graphite coating may include no less than 0.1 wt %, no less than 0.5 wt %, or nor more than 1 wt % of fillers. In some embodiments, the graphite coating may include, for example, from about 1 wt % to about 30 wt % of fillers. While fillers can be added to the surface layer 120 to improve its mechanical properties, it is to be understood that the primary force to connect the surface layer 120 and the lithium metal electrode 110 is not attributed to the fillers or other additives. Instead, the primary bonding force is the interfacial chemical bonding (e.g., lithium-carbon bonding) that is formed during the growth of Li-GIC on the lithium metal electrode 110.

The major surface 112 of the lithium metal electrode 110 can be cleaned before applying a graphite coating. In some embodiments, the lithium metal electrode 110 can be provided with a protective layer such as, for example, a lithium nitride layer, and the protective layer can be removed by, for example, mechanical polishing, before applying the graphite coating. In some embodiments, the cleaning process can be conducted in a dry environment of air. The major surface 112 of the lithium metal electrode 110 may include a layer of native oxide after cleaning. In some embodiments, the major surface 112 of the lithium metal electrode 110 may not have the layer of native oxide, the formed interface Li/Li-GIC may be free from a noticeable amount of oxygen (e.g., 0.1 wt % or less, 0.05 wt % or less, or 0.01 wt % or less).

Various unexpected results and advantages are obtained in exemplary embodiments of the disclosure. One such advantage of exemplary embodiments of the present disclosure is that the surface layer forms a coherent, substantially pinhole-free interface with the underlying lithium electrode, which results from reaction between a graphite coating and the underlying lithium metal surface. The surface layer provides protection for the active lithium metal surface, acts as an electrically conductive, and lithium-ion conductive layer, and exhibits superior electrical, electrochemical, and mechanical properties.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Listing of Exemplary Embodiments

It is to be understood that any one of embodiments 1-12 and 13-30 can be combined.

Embodiment 1 is an electrochemical device component, comprising:
a lithium metal electrode having a first major surface; and
a surface layer disposed on the first major surface of the lithium metal electrode, the surface layer having a composition including a compound of graphite and lithium, the surface layer being electrically conductive and lithium-ion conductive,
wherein the surface layer is chemically compatible with the lithium metal on a first side in contact with the lithium metal electrode, and the surface layer is chemically compatible with electrolyte environments on a second side opposite the first side.
   Embodiment 2 is the electrochemical device component of embodiment 1, wherein the composition of the surface layer comprises no less than 70 wt % of lithium graphite intercalation compound (Li-GIC).
   Embodiment 3 is the electrochemical device component of embodiment 2, wherein the composition of the surface layer comprises no less than 90 wt % of lithium graphite intercalation compound (Li-GIC).
   Embodiment 4 is the electrochemical device component of any one of embodiments 1-3, wherein the composition of the surface layer further comprises one or more fillers.
   Embodiment 5 is the electrochemical device component of any one of embodiments 1-4, wherein the surface layer has an electrical conductivity in the range from about 1×10⁻⁴ S/cm to about 5×10⁴ S/cm at room temperatures.
   Embodiment 6 is the electrochemical device component of any one of embodiments 1-5, wherein the surface layer has a lithium-ion conductivity in the range from about 1×10⁻⁵ S cm²/mol to about 1×10⁻³ S cm²/mol at room temperatures.
   Embodiment 7 is the electrochemical device component of any one of embodiments 1-6, wherein the surface layer is substantially insoluble in one or more electrolytes of the electrolyte environments.
   Embodiment 8 is the electrochemical device component of any one of embodiments 1-7, wherein the surface layer has a thickness in the range from about 10 nm to about 50 microns.
   Embodiment 9 is the electrochemical device component of any one of embodiments 1-8, wherein the first major surface of the lithium metal is a cleaned lithium metal surface with a native oxide layer thereon between the lithium metal and the surface layer.
   Embodiment 10 is the electrochemical device component of any one of embodiments 1-9, wherein the lithium metal electrode is a negative electrode.
   Embodiment 11 is the electrochemical device component of embodiment 10, further comprising a positive electrode.
   Embodiment 12 is the electrochemical device component of embodiment 11, wherein the positive electrode comprises one or more of LiCoO₂, LiMn₂O₄, LiFePO₄, MoS₂, V₂O₅, and elemental sulfur or oxygen.
   Embodiment 13 is a method of making an electrochemical device component, the method comprising:
providing a lithium metal electrode having a first major surface; and
treating the first major surface of the lithium metal electrode to form a surface layer, the surface layer having a composition including a compound of graphite and lithium, the surface layer being electrically conductive and lithium-ion conductive,
wherein the surface layer is chemically compatible with the lithium metal on a first side in contact with the lithium metal electrode, and the surface layer is chemically compatible with electrolyte environments on a second side opposite the first side.
   Embodiment 14 is the method of embodiment 13, wherein treating the first major surface of the lithium metal electrode comprises applying a graphite coating thereon.
   Embodiment 15 is the method of embodiment 14, wherein applying the graphite coating comprises brushing graphite powders or flakes onto the first major surface of the lithium metal electrode.
   Embodiment 16 is the method of embodiment 14, wherein applying the graphite coating comprises buffing graphite compositions onto the first major surface of the lithium metal electrode.
   Embodiment 17 is the method of any one of embodiments 14-16, wherein the graphite coating comprises no less than 70 wt % of graphite.
   Embodiment 18 is the method of any one of embodiments 14-17, wherein the graphite coating further comprises one or more fillers.
   Embodiment 19 is the method of any one of embodiments 14-18, wherein the graphite coating has a thickness in the range from about 10 nm to about 50 microns.
   Embodiment 20 is the method of any one of embodiments 13-19, further comprising cleaning the first major surface of the lithium metal to remove a protective layer thereon before treating the first major surface.
   Embodiment 21 is the method of any one of embodiments 13-20, further comprising cleaning the first major surface of the lithium metal to form a native oxide layer before treating the first major surface.
   Embodiment 22 is the method of any one of embodiments 13-21, wherein the composition of the surface layer comprises no less than 70 wt % of lithium graphite intercalation compound (Li-GIC).
   Embodiment 23 is the method of embodiment 22, wherein the composition of the surface layer comprises no less than 90 wt % of lithium graphite intercalation compound (Li-GIC).
   Embodiment 24 is the method of any one of embodiments 13-23, wherein the surface layer has an electrical conductivity in the range from about 1×10⁻⁴ S/cm to about 5×10⁴ S/cm at room temperatures.
   Embodiment 25 is the method of any one of embodiments 13-24, wherein the surface layer has a lithium-ion conductivity in the range about 1×10⁻⁵ S cm²/mol to about 1×10⁻³ S cm²/mol at room temperatures.
   Embodiment 26 is the method of any one of embodiments 13-25, wherein the surface layer is substantially insoluble in one or more electrolytes of the lithium metal corrosive environments.
   Embodiment 27 is the method of any one of embodiments 13-26, wherein the surface layer has a thickness in the range from about 10 nm to about 50 microns.
   Embodiment 28 is the method of any one of embodiments 13-27, wherein the lithium metal electrode is a negative electrode.
   Embodiment 29 is the method of embodiment 28, further comprising providing a positive electrode.
   Embodiment 30 is the method of embodiment 29, wherein the positive electrode comprises one or more of LiCoO₂, LiMn₂O₄, LiFePO₄, MoS₂, V₂O₅, and elemental sulfur or oxygen.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Table 1 provides abbreviations and a source for all materials used in the Examples below:

TABLE 1

| Abbreviation | Description | Source |
|---|---|---|
| Surface layer | Coating of graphite flakes | TIMCAL LTD., |
| | | WESTLAKE, OH |
| Anode | lithium metal foil | SIGMA-ALDRICH |
| | | CO., ST. LOUIS, MO |
| Cathode | V₂0₅ | SIGMA-ALDRICH |
| | | CO., ST. LOUIS, MO |
| Electrolyte | 1 MOLAR LiPF₆ in EC DEC | MERCK & CO., INC., |
| | | KENILWORTH, NJ |
| Separator | Porous polyolefin | CELLGARD LLC., |
| | | CONCORD, NC |

### Test Methods

The following test methods have been used in evaluating some of the Examples of the present disclosure.

### Isothermal Heat Flow Calorimeter

Isothermal heat flow calorimetry has enabled the direct investigation of the electrolyte reactivity and the development of mossy, dendritic lithium deposits. This technique has been used to characterize the thermal signal from lithium plating and stripping and the parasitic electrolyte reactions occurring in lithium ion cells. This allowed direct observation of the effects of electrolyte variations and surface modifications of the lithium metal electrode. The heat flow calorimeter was obtained from TA instruments (New Castle, Del.) as a TAM III (Thermally Activated Module) in which up to 12 calorimeters can be inserted. The temperature used throughout this work was 40° C. The TAM III is capable of controlling the bath temperature to within a few micro-degrees Centigrade. The calorimeters are equipped with stainless steel sample cans with an outside diameter of 27.6 mm and a length of 60 mm. The sample cans attach to lifters by which the sample can be raised or lowered into the measuring position. The electrochemical cell is inserted into the sample can.

### Examples of Compositions of the Surface Layer on Lithium Metal Electrode

The following illustrate Examples of the preparation of various surface layers according to the present disclosure, as well as Comparative Examples.

### Example 1

A lithium symmetric cell was prepared. Metallic lithium was first brushed with a nylon brush to remove tarnish due to lithium nitride formation to yield a bright metallic surface. Two circular pieces of metal lithium, 2 cm² in area, were cut from the lithium metal foil. The electrodes were then coated with graphite by brushing a graphite powder onto the Li surface. After approximately 30 minute the initially black graphite surface layer turned a golden color. The two surface modified Li electrodes were then assembled into a 2325 coin cell using a porous polyolefin separator (Cellgard 3501) placed between the two lithium electrodes. The cell was then filled with 100 uL of 1M LiClO₄ in a 50:50 by volume blend of ethylene carbonate and propylene carbonate. The coin cell was then placed into the isothermal heat flow calorimeter at 40° C. and electrically connected to a current/voltage source. The symmetric cell was then cycled under constant current conditions whereby each lithium electrode is being stripped of lithium metal while the opposing lithium electrode is being plated with Li metal. After approximately 7 cycles a small thermal peak (FIG. 3) develops due the formation fresh metallic dendrites and reaction of these dendrites with the electrolyte. After approximately 12 cycles the thermal peak decays and continued cycling does not produce any other thermal peaks and the overall thermal energy remains very low.

### Comparative Example A

A lithium symmetric cell was prepared as in example 1 but without a graphite surface modification FIG. 3 shows the results from cycling Example 1 and Comparative Example A in 1 molar LiClO₄ in ethylene carbonate/propylene carbonate mixture (50% v/v) at 40° C. in the isothermal heat flow calorimeter. The current density for both cells was 0.15 mA/cm2 and the deposit and stripping capacity was 0.3 mA/cm². FIG. 3 shows the parasitic thermal energy (joules/mAh reversible) normalized for the reversible capacity. It was observed that Example 1 with graphite coated had substantially lower thermal parasitic energy. A small peak located at around 10 cycles suggests the formation of some areas of surface lithium plating and is similar to Comparative Example A (uncoated cell) but with far lower energy. The occurrence of the small peak in Example 1 (coated cell) may be the result of imperfect coating of the lithium surface given the rather crude application methods used in this initial work.

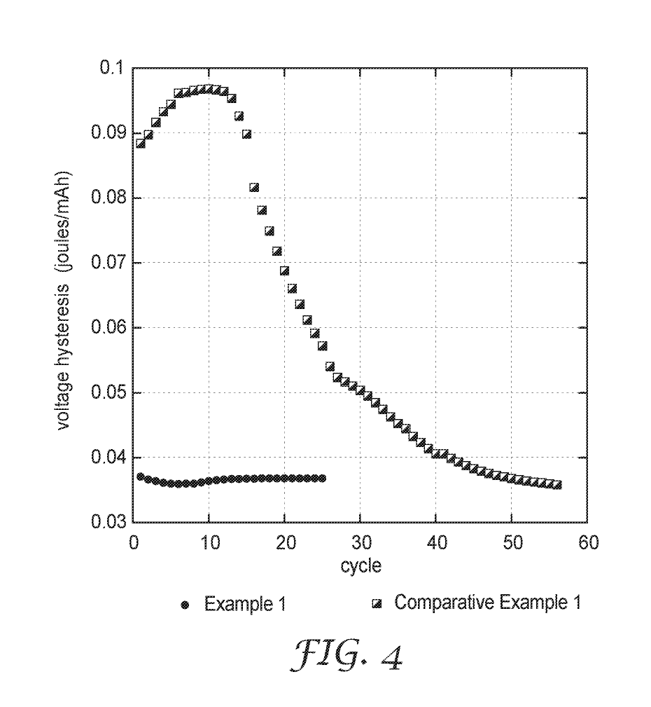

FIG. 4 shows the voltage hysteresis of both cells as a function of cycle number and expressed as energy (joules/mAh). Alternatively FIG. 2 can be viewed as an average cell voltage and represents the cell impedance as a function of cycle number. Note the graphite coated electrodes have quite low hysteresis and it remains stable.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. An electrochemical device component, comprising:
a lithium metal electrode having a first major surface; and
a surface layer disposed on the first major surface of the lithium metal electrode, the surface layer having a composition including a compound of graphite and lithium,
wherein the surface layer is electrically conductive and lithium-ion conductive, and
wherein the surface layer is chemically compatible with the lithium metal on a first side in contact with the lithium metal electrode, and the surface layer is chemically compatible with electrolyte environments on a second side of the surface layer.

2. The electrochemical device component of claim 1, wherein the composition of the surface layer comprises no less than 70 wt % of lithium graphite intercalation compound (Li-GIC).

3. The electrochemical device component of claim 2, wherein the composition of the surface layer comprises no less than 90 wt % of lithium graphite intercalation compound (Li-GIC).

4. The electrochemical device component of claim 1, wherein the composition of the surface layer further comprises one or more fillers.

5. The electrochemical device component of claim 1, wherein the surface layer has a lithium-ion conductivity in the range from about 1×10⁻⁵ S cm²/mol to about 1×10⁻³ S cm²/mol at room temperatures.

6. The electrochemical device component of claim 1, wherein the surface layer has an electrical conductivity in the range from 1×10³ S/cm to about 5×10⁴ S/cm at room temperatures.

7. The electrochemical device component of claim 1, wherein the surface layer is substantially insoluble in one or more electrolytes of the electrolyte environments.

8. The electrochemical device component of claim 1, wherein the surface layer has a thickness in the range from about 10 nm to about 50 microns.

9. The electrochemical device component of claim 1, wherein the first major surface of the lithium metal is a cleaned lithium metal surface with a native oxide layer thereon between the lithium metal and the surface layer.

10. The electrochemical device component of claim 1, wherein the lithium metal electrode is a negative electrode.

11. The electrochemical device component of claim 10, further comprising a positive electrode.

12. The electrochemical device component of claim 11, wherein the positive electrode comprises one or more of LiCoO₂, LiMn₂O₄, LiFePO₄, MoS₂, V₂O₅, and elemental sulfur or oxygen.

13. A method of making an electrochemical device component, the method comprising:
providing a lithium metal electrode having a first major surface; and
treating the first major surface of the lithium metal electrode to form a surface layer, the surface layer having a composition including a compound of graphite and lithium, the surface layer being electrically conductive and lithium-ion conductive,
wherein the surface layer is chemically compatible with the lithium metal on a first side in contact with the lithium metal electrode, and the surface layer is chemically compatible with electrolyte environments on a second side opposite the first side.

14. The method of claim 13, wherein treating the first major surface of the lithium metal electrode comprises applying a graphite coating thereon.

15. The method of claim 14, wherein applying the graphite coating comprises brushing graphite powders or flakes onto the first major surface of the lithium metal electrode.

16. The method of claim 14, wherein applying the graphite coating comprises buffing graphite compositions onto the first major surface of the lithium metal electrode.

17. The method of claim 14, wherein the graphite coating comprises no less than 70 wt % of graphite.

18. The method of claim 14, wherein the graphite coating further comprises one or more fillers.

19. The method of claim 14, wherein the graphite coating has a thickness in the range from about 10 nm to about 50 microns.

20. The method of claim 13, further comprising cleaning the first major surface of the lithium metal to remove a protective layer thereon before treating the first major surface.
